(19) United States
(12) Patent Application Publication
(10) Pub. No.: US 2021/0039323 A1
(43) Pub. Date: Feb. 11, 2021

(54) VERIFICATION OF ADDITIVE MANUFACTURING PROCESSES

(71) Applicant: RENISHAW PLC, Wotton-Under-Edge, Gloucestershire (GB)

(72) Inventor: Thomas David FARR, Lydney (GB)

(73) Assignee: RENISHAW PLC, Wotton-Under-Edge, Gloucestershire (GB)

(21) Appl. No.: 16/967,062

(22) PCT Filed: Jan. 31, 2019
(86) PCT No.: PCT/GB2019/050268

§ 371 Date: Aug. 3, 2020

(30) Foreign Application Priority Data
Feb. 1, 2018 (GB) 1801690.7

(51) Int. Cl. B29C 64/393; G01B 5/008; G01B 21/04; B33Y 50/02; B33Y 10/00; B29C 64/153

(52) U.S. Cl. CPC B29C 64/393; G01B 5/008; B29C 64/153; B33Y 50/02; B33Y 10/00; G01B 21/042

(57) ABSTRACT

A method of verifying a build of a part, in which the part is built in an additive manufacturing process by layerwise consolidation of material and a verification artefact for use in the method including building a verification artefact together with the part in the additive manufacturing process, measuring a feature of the verification artefact with a surface sensing probe to determine measured geometric dimensions of the feature, and qualifying the build of the part based upon a comparison between the measured geometric dimension and an expected dimension for the feature.

### FIELD OF INVENTION

This invention concerns processes and apparatus for the verification of an additive manufacturing process and, in particular, but not exclusively, determination of whether an additive build is carried out within an acceptable processing window.

### BACKGROUND

Additive manufacturing or rapid prototyping methods for producing parts comprise layer-by-layer solidification of a flowable material. There are various additive manufacturing methods, including powder bed systems, such as selective laser melting (SLM), selective laser sintering (SLS), electron beam melting (eBeam) and stereolithography, and non-powder bed systems, such as fused deposition modelling, including wire arc additive manufacturing (WAAM).

In selective laser melting, a powder layer is deposited on a powder bed in a build chamber and a laser beam is scanned across portions of the powder layer that correspond to a cross-section (slice) of the workpiece being constructed. The laser beam melts or sinters the powder to form a solidified layer. After selective solidification of a layer, the powder bed is lowered by a thickness of the newly solidified layer and a further layer of powder is spread over the surface and solidified, as required. In a single build, more than one part can be built, the parts spaced apart in the powder bed.

An advantage of additive manufacturing is that parts can be built that would otherwise be impossible or extremely difficult to build using subtractive manufacturing techniques. For example, additive manufacturing can be used to build complex lattice structures, porous structures and conformal cooling channels within a part. To determine whether such features are built to specification, for example using conventional contact probing techniques, can be difficult, if not impossible, because, for example, access to a feature of interest may be extremely limited. In subtractive manufacturing, to machine a feature, tooling is applied to machine a surface. Sufficient access to that surface for machining often means that there will be sufficient access to the surface for probing. However, this is not the case for additive manufacturing.

Non-contact methods, such as CT scans, can be used for analysing an additively built part but these methods are expensive and time-consuming and thus unsuitable for use in the mass-production of parts.

### SUMMARY OF THE INVENTION

According to a first aspect of the invention there is provided a method of verifying a build of a part, in which the part is built in an additive manufacturing process by layerwise consolidation of material, the method comprising building a verification artefact together with the part in the additive manufacturing process, measuring a feature of the verification artefact with a surface sensing probe to determine measured geometric dimensions of the feature, and qualifying the build of the part based upon a comparison between the measured geometric dimension and an expected dimension for the feature.

The feature of the verification artefact acts as a proxy for the dimensions of features of the part that are more difficult or impossible to measure using the surface sensing probe. The feature on the verification artefact is arranged to be measured easily and relatively quickly using the surface sensing probe and is used to generate data that provides an insight into at least one feature of the part that is more difficult to measure using the surface sensing probe.

The expected dimension may comprise a range of acceptable dimensions, such as a range about a mean value, and qualifying the build of the part may comprise comparing the measured geometric dimension to the range of acceptable dimensions.

Qualifying the build may comprise determining whether the build was out-of-specification (i.e. a build specification), which may constitute a build failure (a go/no-go condition). There may be a known correlation between the deviation in the geometric dimensions of the feature and a failure mode of the build. Such a known correlation may be stored in a look-up table. The method may comprise searching the look-up table using the deviation to identify whether the failure mode has occurred.

Qualifying the build may comprise determining whether the part should be subjected to further tests, such as a CT scan, to determine whether the part meets pre-set part specifications.

The surface sensing probe may be a probe requiring “a line of sight” from the probe sensing element to the surface being measured in order to measure the surface, e.g. the probe cannot measure a surface separated from the probe sensing element by solid material such as material of the verification artefact. The surface sensing probe may comprise a contact or tactile surface sensing probe, such as a touch trigger probe or a scanning probe, wherein a contact element is brought into contact with the surface. Alternatively, the surface sensing probe may comprise a non-contact probe, such as a vision probe, a capacitance sensing probe or an eddy current sensing probe.

The method may comprise measuring the feature of the verification artefact on a coordinate positioning machine, such as a coordinate measuring machine, machine tool or a gauge, such as Renishaw's Equator™ gauging system.

The measured dimensions may be deviations of the feature of the verification artefact from a nominally identical feature of a master (or “golden”) artefact. The master artefact may be an artefact machined with a corresponding feature or another (nominally identical) one of the verification artefact built in an additive manufacturing process verified as acceptable, for example through the use of other (potentially slower) testing methods, such as CT scans. Dimensions of the master artefact may be determined using a coordinate positioning machine (CMM), whereas the absolute dimensions of the (non-master) artefact may not be determined but compared to the dimensions of the master artefact in a gauging process. Such a gauging process may be in accordance with the methods described in WO2011/107729 and WO2011/107746, which are incorporated herein by reference.

The measured dimensions may be compared to statistical data, such as an average dimension for the feature for a plurality of other (nominally identical) ones of the verification artefact built in a plurality of additive manufacturing processes verified as acceptable. The statistical data may comprise an average (centre) value for the dimensions and a standard deviation for acceptable values in the dimensions of the feature. The method may comprise determining whether the measured dimensions fall outside an acceptable processing window as determined from the average and standard deviation values. Such statistical data may be gathered through builds based upon an appropriate design of experiments (DOE) to capture expected variation that can occur in builds complying with the build specifications.

Comparing the verification artefact to the master artefact may comprise locating the verification artefact and the master artefact in approximately the same position within the coordinate positioning machine during measurement. Accordingly, the method may comprise using the same fixture for mounting both the master artefact and the verification artefact in the coordinate positioning apparatus in substantially the same position during measurement of each of the verification artefact and the master artefact.

The verification artefact may be built on a removable build substrate during the additive manufacturing process (such as a build substrate as described in U.S. Pat. No. 5,753,274) and the removable build substrate, with the verification artefact thereon, mounted in the coordinate positioning machine for measurement of the verification artefact. The verification artefact may be built in one of a plurality of pre-set positions on the build substrate. Accordingly, the verification artefact may occur in one of a plurality of positions within a measurement volume of the coordinate positioning apparatus. To locate the master artefact (which may be a machined part not connected to a build substrate) in the substantially same position, the method may comprise mounting the master artefact in the coordinate positioning apparatus using a mounting plate, the mounting plate have alignment features thereon for positioning the master artefact in any one of the plurality of positions corresponding to the pre-set positions of the verification artefact on the build substrate when the build substrate is mounted in the coordinate positioning apparatus. In this way, a single master artefact may be used for mastering the coordinate positioning apparatus for multiple positions of the verification artefact in the measurement volume.

Alternatively, the dimensions of the at least one feature may be compared to nominal dimensions defined in design specifications, such as a CAD model or the like.

One or more of the following build attributes may be determined from the measured geometric dimension:
1) Errors in scaling of part in an evaluation direction, (a change in phase of the material from powder to liquid and then to solid results in shrinkage in the material volume. Accordingly, additively manufactured parts are typically built slightly oversize (or scaled) to take account of this shrinkage);
2) Errors in spot compensation, (the melt pool to typically larger than the spot diameter of an energy beam used to form the melt pool. Accordingly, at edges of the part, positioning of the spot is adjusted to ensure that the melt pools do not solidify material beyond a desired extent of the part. This adjustment is called spot compensation);
3) An attribute of a controlled atmosphere in which the verification artefact, and therefore, the part, is built, for example humidity of the atmosphere, adequacy of gas flow for removing particles generated during the additive manufacturing process, oxygen content in the atmosphere;
4) Errors in an alignment of a build plate with a build (Z) direction;
5) Adequacy of the scanning parameters;
6) Energy beam quality;
7) Cleanliness of optics during the build;
8) Beam deflection;
9) Dosing anomalies;
10) Drift of a calibration of an energy beam scanner, e.g. steering optics of a laser beam scanner;
11) Drift of focusing optics of an energy beam scanner, e.g. dynamic focusing optics of a laser beam scanner.

These attributes are features of the build that ideally are fixed between builds and between machines but, in fact, can vary and are distinguished from scanning parameters, such as laser power, scanning speed, exposure time, point distance and spot size, which can be varied by an operator as part of a design of a build in order to obtain the desired outcome.

The feature may comprise at least two parallel planar surfaces spaced apart in an evaluation direction perpendicular to the two or more planar surfaces. The method comprises measuring a relative location of the at least two parallel planar surfaces in the evaluation direction and determining a deviation between the measured relative location to an expected relative location. The deviation may provide a measure of scaling (if any) of the verification artefact in the evaluation direction. The method may comprise determining that a failure occurred in the building of the part if scaling of the verification artefact in the evaluation-direction falls outside an acceptable processing window.

The evaluation direction may be a direction perpendicular to a working plane in which the layers are formed in the additive manufacturing process (referred to hereafter as the “Z-direction” for which Z-scaling is determined).

The evaluation direction may be a direction parallel to a working plane in which the layers are formed in the additive manufacturing process (for which XY scaling is determined).

The scaling may be determined by averaging a plurality of the deviations determined for the at least two parallel planar surfaces.

The verification artefact may be built as a separate object from the part during the additive manufacturing process (both the verification artefact and the part may be built connected to the same build substrate but later separated on being detached from the build substrate). Alternatively, the verification artefact may be built integrated into the part during the additive manufacturing process (and optionally, later separated therefrom).

The method may comprise building indicia into the verification artefact that encode information about the build. For example, the information may comprise build settings, such one or more of build time and date; material parameters; identification number of the additive manufacturing machine in which the verification artefact is built, machine settings, for example, scanning parameters; unique artefact identification number and build position of the verification artefact in a build volume of the additive manufacturing machine. The indicia may be readable using the surface scanning probe. The indicia may comprise one or more coding features each having a set shape, such as raised dots, on a surface of the verification artefact, wherein the information is encoded through the formation of different dimensions, such as heights, depths or widths, of the set shape. The variation in the dimension need not be a binary variation (low-high or fat/thin) but include a number of dimensional variations greater than two, this allowing the encoding of the information using a series of raised features with a radix greater than two (although it will be understood that the invention is not limited to a system that uses positional notation for encoding the data, for example, each of different possible dimensions of the coding feature could be used to encode different orders of magnitude).

The method may comprise building encoding features on the part built together with the verification artefact associating the part with the verification artefact. In this way, if the part fails at a later date, for example during use,

According to a second aspect of the invention there is provided a method of verifying a build of a part, in which the part is built in an additive manufacturing process by layerwise consolidation of material, the part built together with a verification artefact having a feature measurable with a surface sensing probe, the method comprising receiving measured geometric dimensions of the feature obtained by measuring the feature with the surface sensing probe, determining a deviation in the measured geometric dimension from an expected dimension for the feature and qualifying the build of the part based upon the deviation.

According to a third aspect of the invention there is provided a method of determining an expected dimension to be used in the method of the first or second aspects of the invention, the method comprising carrying out a plurality of builds, wherein each build comprises the building of a part together with a verification artefact, measuring a feature of each artefact with a surface sensing probe to determine a measured geometric dimension of the feature, verifying each part to determine whether the part meets predetermined specifications for the part, and determining the expected dimension from the measured geometric dimensions for ones of the verification artefacts built together with parts deemed to meet the predetermined specifications.

Each build may comprise the building of a nominally identical artefact and a nominally identical part with nominally identical scanning parameters. However, other factors may be varied, such as ambient temperature, humidity, powder condition and age (potentially affecting particle size distribution, oxidisation and moisture retention), age of filters for removing particles from a gas flow, alignment of a build substrate and the additive manufacturing machine in which the build is carried out. A design of experiments may be carried out in order to capture expected variations that are within a specification for the builds.

The expected dimension may comprise an average of the measured geometric dimensions for the verification artefacts built together with parts deemed to meet the predetermined specifications. The expected dimensions may additionally comprise a standard deviation in the measured geometric dimensions about the average and/or a range of acceptable values for the geometric dimension about the average.

Each part may be verified using different or additional sensing devices to the surface sensing devices or different means used to measure the feature of each artefacts. For example, the parts may be verified using measurements from a CT scan or the parts may be destructively tested.

By carrying out this method, geometric dimensions of the verification artefact may be correlated with qualification of the nominally identical parts such that, for future builds, measurement of the verification artefact alone and comparison of the measured geometric dimension to the expected dimensions is sufficient to verify a build of the part.

The method may comprise carrying out the plurality of builds under varied conditions within the processing window of a subsequent mass manufacture of the parts. For example, the builds may be carried out in multiple different machines of the type specified for the mass manufacture, different environmental conditions, with different batches of material, etc.

According to a fourth aspect of the invention there is provided a method of determining an expected dimension to be used in the method of the first or second aspects of the invention, the method comprising receiving measured geometric dimensions of a feature of a plurality of artefacts, each artefact built together with a part using an additive manufacturing process in a plurality of nominally identical builds, the measured geometric dimensions determined by measuring the feature with a surface sensing probe, receiving data on a verification of whether each part meets predetermined specifications for the part, and determining the expected dimension from the measured geometric dimensions for the ones of the verification artefacts built together with parts deemed to meet the predetermined specifications.

According to a fifth aspect of the invention there is provided a method of carrying out variability management of an additive manufacturing apparatus comprising carrying out a plurality of builds with the additive manufacturing apparatus, wherein each build comprises the building of a verification artefact, each artefact having a nominally identical feature, measuring the nominally identical feature of each artefact with a surface sensing probe to determine a measured geometric dimension of the feature, and generating a flag that maintenance of the additive manufacturing apparatus is required based on a trend in the measured geometric dimensions across the plurality of builds.

According to a sixth aspect of the invention there is provided a method of carrying out variability management of an additive manufacturing apparatus comprising receiving measured geometric dimensions of a nominally identical feature of a plurality of artefacts, each artefact built in separate builds in the additive manufacturing apparatus, the measured geometric dimensions determined by measuring the nominally identical feature with a surface sensing probe, and generating a flag that maintenance of the additive manufacturing apparatus is required based on a trend in the measured geometric dimensions across the plurality of builds.

According to a seventh aspect of the invention there is provided a method of correlating build outcomes across a build volume of an additive manufacturing apparatus comprising building a plurality of nominally identical artefacts at different locations in the build volume, measuring geometric dimensions of a feature of each of the verification artefacts with a surface sensing probe, and comparing the measured geometric dimensions of each artefact to obtain a correlation between a build outcome for one location in the build volume and build outcomes for other locations in the build volume.

The build outcomes may be for one or more of the attributes described above.

The method may allow an operator to interpolate, from an outcome of a build of a verification artefact in one location in the build volume, the nature of the build at other locations in the build volume. Accordingly, from the building of a corresponding artefact in one location in the build volume in future builds, it may be possible to obtain an indication of the “health” of the build outcomes at other locations in the build volume.

According to an eighth aspect of the invention there is provided a method of correlating build outcomes across a build volume of an additive manufacturing apparatus comprising receiving geometric dimensions of a feature of each of a plurality of nominally identical artefacts measured with a surface sensing probe, the plurality of nominally identical artefacts built at different locations in the build volume, and comparing the measured geometric dimensions of each artefact to obtain a correlation between a build outcome for one location in the build volume and build outcomes for other locations in the build volume.

According to a ninth aspect of the invention there is provided a data carrier having stored thereon instructions, which, when executed by a processor, cause the processor to carry out the method of the second, fourth, sixth and/or eighth aspects of the invention.

The data carrier may be a suitable medium for providing a machine with instructions such as non-transient data carrier, for example a floppy disk, a CD ROM, a DVD ROM/RAM (including −R/−RW and +R/+RW), an HD DVD, a Blu Ray™ disc, a memory (such as a Memory Stick™, an SD card, a compact flash card, or the like), a disc drive (such as a hard disc drive), a tape, any magneto/optical storage, or a transient data carrier, such as a signal on a wire or fibre optic or a wireless signal, for example a signals sent over a wired or wireless network (such as an Internet download, an FTP transfer, or the like).

According to a tenth aspect there is provided a verification artefact used in connection with the method of the first to eighth aspects of the invention, the verification artefact comprising a feature measurable with a surface sensing probe.

The verification artefact may be designed with features that would not ordinarily fail due to droop or thermal stress during the additive manufacturing process.

According to an eleventh aspect there is provided a method of encoding information into an object built using an additive manufacturing process, in which the object is built by layerwise consolidation of material, the method comprising building indicia into the verification artefact that encode information about the build, the indicia readable using a surface scanning probe.

For example, the information may comprise build settings, such as one or more of build time and date; material parameters; identification number of the additive manufacturing machine in which the verification artefact is built, machine settings, for example, scanning parameters; unique artefact identification number and build position of the verification artefact in a build volume of the additive manufacturing machine.

The indicia may comprise one or more coding features each having a set shape, such as raised dots, on a surface of the verification artefact, wherein the information is encoded through the formation of different dimensions, such as heights, depths or widths, of the set shape. The variation in the dimension need not be a binary variation (low-high or fat/thin) but include a number of dimensional variations greater than two, this allowing the encoding of the information using a series of raised features with a radix greater than two (although it will be understood that the invention is not limited to a system that uses positional notation for encoding the data, for example, each of different possible dimensions of the coding feature could be used to encode different orders of magnitude rather than different digits within a single order of magnitude wherein a position of the coding feature denotes the magnitude).

### BRIEF DESCRIPTION OF THE DRAWINGS

FIG. 1 is a flowchart showing a method according to an embodiment of the invention;

FIG. 2 is a perspective view of a verification artefact according to an embodiment of the invention;

FIG. 3 is plan view of the verification artefact shown in FIG. 2;

FIG. 4 is a side view of the verification artefact shown in FIG. 2;

FIG. 5 is a cross-sectional view of the verification artefact shown in FIG. 2 in the plane A-A;

FIG. 6 is a cross-sectional view of the verification artefact shown in FIG. 2 in the plane B-B; and

FIG. 7 is a cross-sectional view of the verification artefact shown in FIG. 2 in the plane C-C.

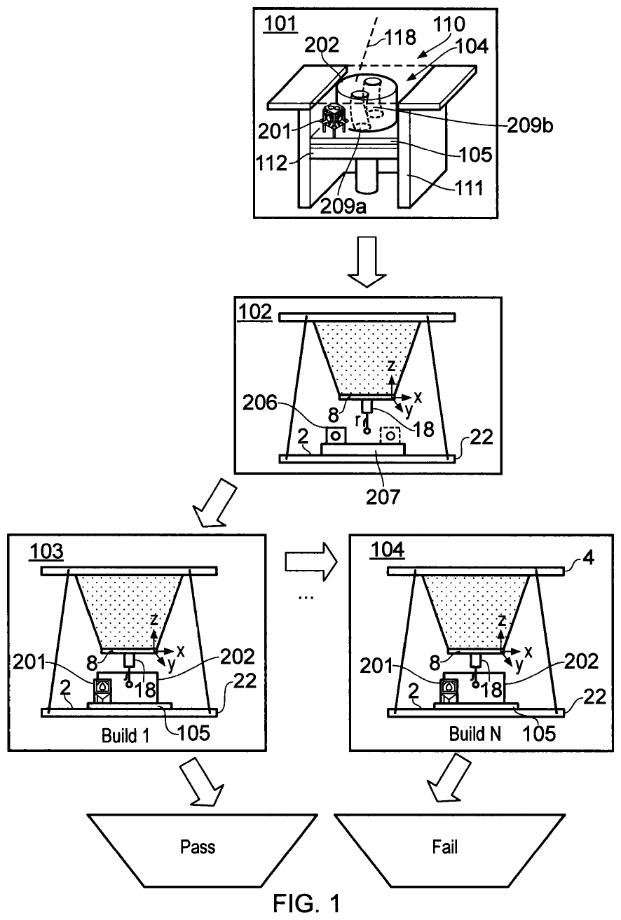

### DESCRIPTION OF EMBODIMENTS

Referring to the Figures, a method of verifying a build of a part according to an embodiment of the invention comprises building 101 a verification artefact 201 together with the part 202 in an additive manufacturing process, in which the part is built by layerwise consolidation of material. In this embodiment, the additive manufacturing process is a powder bed fusion process in which an energy beam, such as a laser or electron beam 118 is scanned across a working plane 110 to melt powder of a powder bed 104 at selected locations in the powder bed 104. A build volume available for a build is defined by the extent a build platform 112 is lowerable into a build sleeve 111.

The verification artefact 201 and part 202 are built on a build substrate 105. The verification artefact 201 is connected to the build substrate 105 by supports 227a to 227d and detachable therefrom at the end of or during the verification process. The part 202 may also be detachably attached to the build substrate 105 by frangible supports such that is may be removed therefrom or (the entire or a portion of) the build substrate 105 may form part of the final part. The part 202 may comprise features, for example internal conformal channels 209a, 209b, which cannot easily be measured using a surface sensing probe, such as a contact probe 18.

After the additive manufacturing process has finished, the build substrate 105, with the verification artefact 201 and part 202 attached thereto, is removed from the additive manufacturing apparatus for measurement of the verification artefact 201 using the contact probe 18 of a coordinate positioning machine. In this embodiment, the coordinate positioning machine is a gauge 8, such as a Renishaw™ Equator™ gauge, which verifies a part by comparing measurements of the part to a nominally identical master artefact.

A gauge 8 is typically a coordinate positioning machine that may not provide accurate measurements over the extent of a part but provides repeatable measurements within a small measurement space, for example a volume of a few millimetres. This makes such a gauge suitable for comparative measurements, in which deviations between parts being measured and a master artefact are expected to be of or less than a size of the measurement space for which repeatable measurements can be achieved.

To make such a comparison, the gauge 8 is first “mastered” 102 by measuring a master artefact 206 with the gauge 8. The master artefact 206 may be a machined part having features corresponding to those (but not necessarily identical to those) of the additively manufactured artefact (for example, the machined part may comprise circular side counterbores (which are easy to machine but difficult to reliably build using additive manufacturing) rather than tear-drop shaped counterbores (which can be reliably built using additive manufacturing but are difficult to machine)) or the master artefact 206 may be an additively manufactured artefact from a build that has been checked by other means as meeting the specifications for the build.

The master artefact 206 is built of the same material as the verification artefact 201 such that both artefacts 201, 206 undergo similar thermal expansions and contractions.

The master artefact 206 is measured in a position within a measurement volume of the gauge 8, which substantially corresponds to a position in which the verification artefact 201 will be later measured. The verification artefact 201 may be built on the build substrate 105 in one of a number of predetermined positions. A mounting plate 207 is used to ensure that the master artefact 206 is positioned in the measurement volume in a corresponding position. The mounting plate 207 comprises alignment features for aligning the master artefact 206 to any one of the predetermined positions (the dotted lines indicating the positioning of the master artefact 206 in another position on the mounting plate 207). In an alternative embodiment, the verification artefact 201 is removed from the build substrate 205 and both the master artefact 206 and artefact 201 mounted in the common fixture in the measurement volume. This latter embodiment may be preferable when a thickness of the build substrate is unknown or variable.

The build substrate 105 with the verification artefact 201 and part 202 attached thereto is then mounted in the measurement volume on the gauge 8 and features of the verification artefact 201 are measured 103 using the gauge 8. The build substrate 105 may have the same cross-section as the mounting plate 207 such that use of the same fixturing to mount the build substrate 105 in the build volume as that used to mount the mounting plate 207 ensures that both are mounted in the same position in the measurement volume. As the verification artefact 201 is built at a specific location on the build substrate 105, fixturing the build substrate 105 in this way should ensure that the verification artefact 201 is located in the required position in the measurement volume.

Geometric measurements of the features of the verification artefact 201 are compared to geometric measurements of the corresponding features of the master artefact 206 and the build of the part 202 is qualified, as described in more detail below, based upon this comparison. Failure of the build to meet preset requirements may result in rejection of the part 202. This verification may be carried out sequentially 103 to 104 for a plurality of builds 1 to N.

The measurement steps 102 to 104 may be semi- or completely automated under the control of controller 22. Controller 22 may comprise a processor under the control of software, which, when executed causes the processor to carry out the method as described herein.

After verification, the verification artefact 201 may be separated from the build substrate 105 and stored as a record of the build process. Storage of the verification artefact 201 allows the artefact to be remeasured at a later date, for example in the case of a failure of the part 202.

In this way, the build of the part is verified, not through measurement of the part 202 itself, but through measurement of the verification artefact 201 as a proxy for whether unmeasurable or difficult to measure features of the part 202 have been built correctly. The features of the verification artefact 201 can be designed such that they can be easily measured using the contact probe 18.

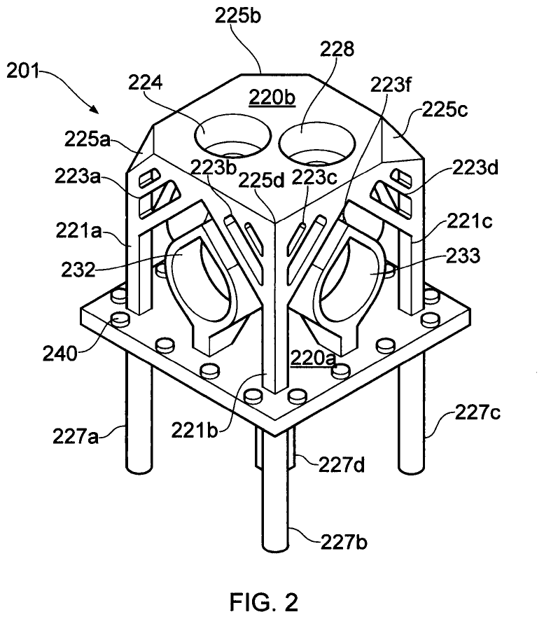

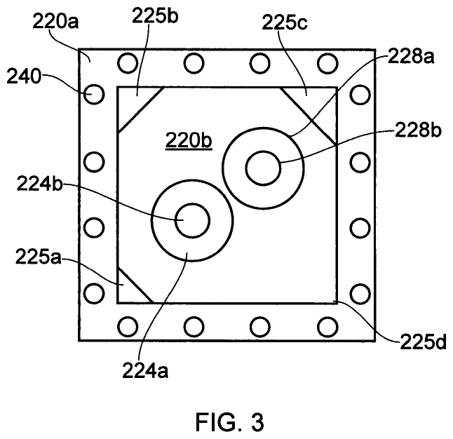

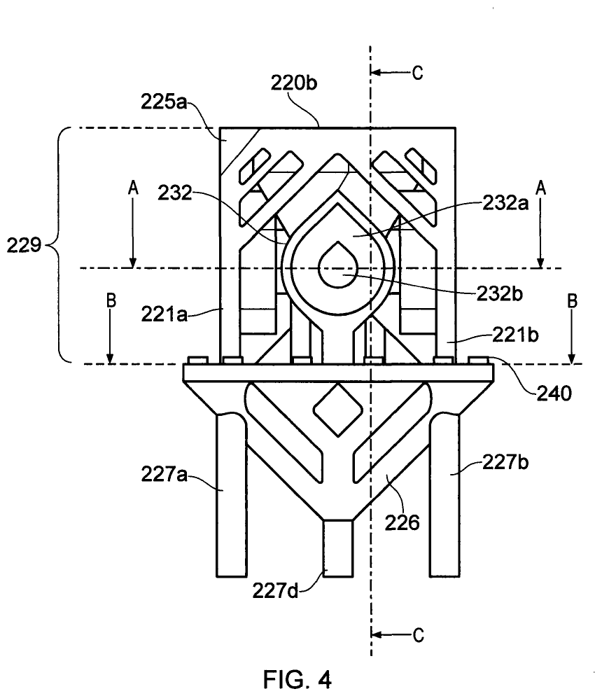

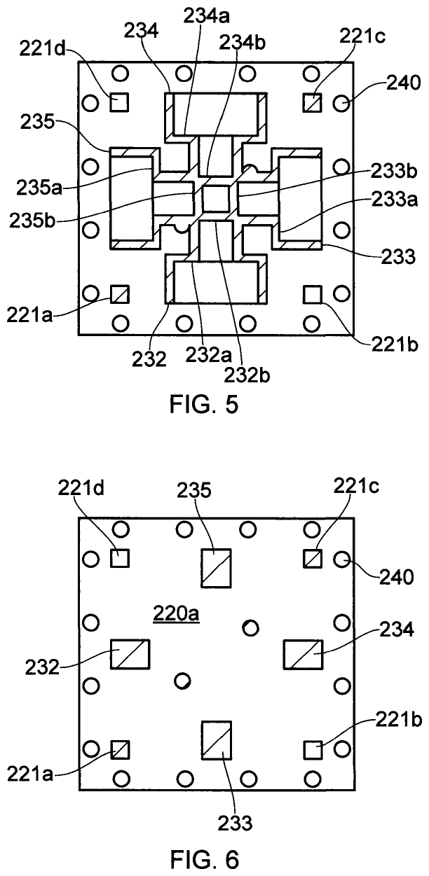

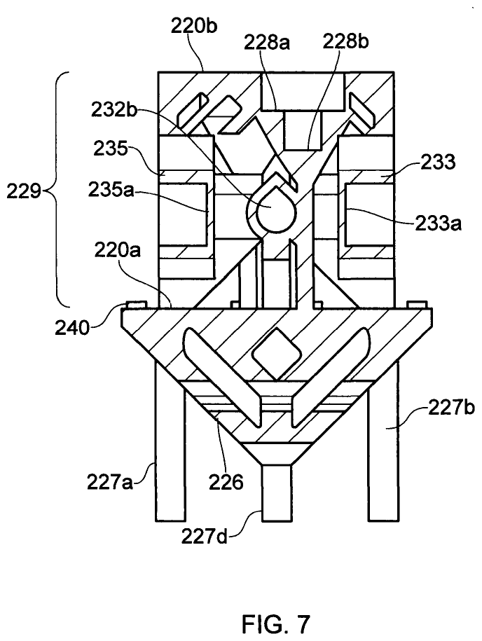

Referring to FIGS. 2 to 6, in this embodiment the verification artefact 201 comprises two parallel planar faces 220a, 220b joined by four perpendicular columns 221a to 221d and four tear-drop shaped features 232, 233, 234, 235. The lower planar face 220a has a larger area than the upper planar face 220b. The upper planar face 220b, perpendicular columns 221a to 221d and four tear-drop shaped features 222a to 222d form a substantially cuboid portion 229 extending from the lower planar face 220a. The upper planar surface 220b has two counterbores 224, 228 therein having parallel planar surfaces 224a, 224b and 228a, 228b, respectively, at different depths within the bore. These surfaces 224a, 224b, 228a, 228b are also parallel with the planar faces 220a, 220b.

The verification artefact 201 comprises alignment features for aiding an operator in orienting the verification artefact 201 in the coordinate positioning apparatus. In this embodiment, the cuboid section 229 has three chamfered corners 225a to 225c and one right angled corner 225d. The chamfers are of different geometric proportions, in this embodiment having different dimensions. These corners 225a to 225d provide visual and measurable features for the correct alignment of the verification artefact 201 in a desired orientation.

The four tear-drop shaped features 232, 233, 234, 235 also comprise counterbores having parallel planar surfaces 232a, 232b; 233a, 233b; 234a, 234b and 235a, 235b, respectively, at different depths within the bore. The planar surfaces 232a, 232b; 233a, 233b; 234a, 234b; 235a, 235b are perpendicular to the planar faces 220a, 220b and planar surfaces 224a, 224b and 228a, 228b. A rear-face of each tear-drop shaped feature 232, 233, 234, 235 extends at an angle at or greater than a threshold angle for droop specified for additive builds in the target material. In this embodiment, the threshold angle is 45 degrees or greater, to the horizontal, such that the rear-faces eventually converge together to form a combined support for the upper planar face 220b. However, different threshold angles may be used with different materials and hence the verification artefact 201 may be varied for different materials.

Extending at an angle, such as 45 degrees, from either side of each column 221a to 221c to the upper planar face 220b are angular struts 223a to 223d.

The lower planar surface 220a is supported by a lattice structure 226 in the general shape of an inverted pyramid. The five supports 227a to 227d extend from below the lower planar surface 220a and/or lattice structure 226. The majority of downward facing surfaces extend at an angle to the horizontal of greater than the threshold angle below which there is a chance that the molten material will droop during the fusion process. A principle of the verification artefact is that it will build using the selected additive manufacturing process if the additive manufacturing apparatus is calibrated and operating correctly. The verification artefact is designed such that build of the verification artefact is unlikely to exhibit droop, crack or warp even if the build is operating well outside predetermined specifications. The angles of the downwardly facing surfaces, the small horizontal bridging surfaces and the well supported planar surfaces ensures that this is the case. (The verification artefact would not typically be used in the selection of an additive manufacturing process, such as the selection of appropriate scanning parameters/scanning conditions for building the part. Other artefacts may be used for such developments, such as tensile test bars).

Information about the build, such as one or more of build time and date; material parameters; identification number of the additive manufacturing machine in which the verification artefact is built, machine settings, for example, scanning parameters; unique artefact identification number and build position of the verification artefact in a build volume of the additive manufacturing machine, may be hard coded into the verification artefact 201. In this embodiment, encoding features in the form of raised circular “dots” 240 are formed in the planer surface 220a. These encoding features can be measured by the contact probe 18. A height of each dot is assigned a value. In this embodiment, the dots comprise two possible heights, allowing the encoding of the information in a binary 16-bit word format. The different heights may for example, be different multiples of the layer thickness of each layer of the powder bed. Typically, the layer thickness would be 20 to 100 micrometres and such differences can be easily resolved using a coordinate positioning machine, although noise introduced by “splatter” and sintered powder particles may have to be taken into account. In this embodiment, the difference in height is 0.5 mm or approximately 10 layers. The different shaped corners 225a to 225d of the cuboid section 229 act as identifiers to identify where the 16-bit word starts and finishes. However, it will be understood that the start and finish of the encoding features may be identified by other unique geometric features.

In this embodiment, the 16-bit word encoded within the encoding features 240 is a unique identifier for the verification artefact 201 and can be used to identify a record within a database in which the measurement values of the geometric artefact are stored.

The part built together with the verification artefact may be similarly linked to the verification artefact and/or database record using the same or a different unique identifier. Such an identifier may be structurally encoded into the part during the additive manufacturing process or may be applied to the part in a subsequent process.

A number of build attributes can be verified as being within build specifications through the comparison of deviations in geometric dimensions of the verification artefact 201 from corresponding features of the master artefact 206. This may be carried out automatically by a computer program. The attributes may include:

### Z-Scaling

A measurement of the relative positions of planar surfaces 220a, 220b, 224a, 224b, 228a and 228b for artefact 201 gives a measure of whether scaling of the build in the Z-direction, perpendicular to a working plane 110, has correctly compensated for shrinkage of the part 202 that occurs in the Z-direction. A comparison of these relative positions on the verification artefact 201 to those of the master artefact 206 provide a measure of a deviation of the build from a “golden” or “ideal” build. If the deviation is outside of an acceptable process variation for the build then the build of the part may be deemed to have failed.

### XY Scaling

A measurement of the relative positions of planar surfaces 232a, 232b; 233a, 233b; 234a, 234b and 235a, 235b for artefact 201 gives a measure of whether scaling of the build in the XY-direction, parallel to a working plane 110, has correctly compensated for shrinkage of the part 202 that occurs in the XY direction. A comparison of these relative positions on the verification artefact 201 to those of the master artefact 206 provide a measure of a deviation of the build from a “golden” or “ideal” build. If the deviation is outside of an acceptable process variation for the build then the build of the part may be deemed to have failed.

### Spot Compensation

Once scaling has been factored into the measured values of the vertical planar surfaces 232a, 232b; 233a, 233b; 234a, 234b and 235a, 235b, a measure of spot compensation can be determined from averaging deviations in the measured positions of these surfaces 232a, 232b; 233a, 233b; 234a, 234b and 235a, 235b from the master artefact.

To determine the acceptable process variation from the master artefact, a series of builds may be carried out and tested using a separate measurement technique to determine whether the builds meet the build specifications. For example, the parts from these builds may be measured using standard techniques, such as CT scans and destructive testing. The verification artefacts from the builds deemed to be successful from the testing are then measured, for example through comparative measurements to the master artefact 206 and an acceptable process variation for the geometric dimension from those of the master artefact are determined. The plurality of artefacts may be built as part of a design of experiments to identify process variation that occurs for successful builds.

The determination of acceptable process variations may further comprise building a plurality of artefacts at different locations throughout the build volume to correlate changes in the geometric dimensions of the verification artefact with location in the build volume.

It will be understood that alterations and modifications may be made to the described embodiments without departing from the invention as described herein.

1. A method of verifying a build of a part, in which the part is built in an additive manufacturing process by layerwise consolidation of material, the method comprising building a verification artefact together with the part in the additive manufacturing process, measuring a feature of the verification artefact with a surface sensing probe to determine measured geometric dimensions of the feature, and qualifying the build of the part based upon a comparison between the measured geometric dimension and an expected dimension for the feature.

2. The method according to claim 1, wherein the expected dimension comprises a range of acceptable dimensions and qualifying the build of the part comprises comparing the measured geometric dimension to the range of acceptable dimensions.

3. The method according to claim 1, wherein qualifying the build comprises determining whether the build was out-of-specification.

4. The method according to claim 1, wherein qualifying the build comprises determining whether the part should be subjected to further tests.

5. The method according to claim 1, wherein the surface sensing probe comprises a contact or tactile surface sensing probe.

6. The method according to claim 5, comprising measuring the feature of the verification artefact on a coordinate positioning machine.

7. The method according to claim 1, comprising comparing the measured dimensions of the feature of the verification artefact to dimensions of a nominally identical feature of a master artefact.

8. The method according to claim 7, comprising comparing the measured dimensions of the feature of the verification artefact to the dimensions of the nominally identical feature of the master artefact in a gauging process.

9. The method according to claim 1, comprising comparing the measured dimensions to statistical data for the feature for a plurality of other ones of the verification artefact built in a plurality of additive manufacturing processes verified as acceptable.

10. The method according to claim 1 comprising using the same fixture for mounting both the master artefact and the verification artefact in the coordinate positioning apparatus in substantially the same position during measurement of each of the verification artefact and the master artefact.

11. The method according to claim 1, comprising building the verification artefact on a removable build substrate during the additive manufacturing process and mounting the removable build substrate, with the verification artefact thereon, in the coordinate positioning machine in a set position for measurement of the verification artefact.

12. The method according to claim 1, wherein one or more of the following build attributes are determined from the measured geometric dimension:
i. scaling of part in an evaluation direction;
ii. errors in spot compensation;
iii. an attribute of a controlled atmosphere in which the verification artefact, and therefore, the part, is built;
iv. alignment of a build plate with a build direction;
v. adequacy of the scanning parameters;
vi. energy beam quality;
vii. cleanliness of optics during the build;
viii. beam deflection;
ix. dosing anomalies;
x. drift of a calibration of an energy beam scanner; and
xi. drift of focusing optics of an energy beam scanner.

13. The method according to claim 1, wherein the feature comprises at least two parallel planar surfaces spaced apart in an evaluation direction perpendicular to the at least two planar surfaces, the method comprises measuring a relative location of the at least two parallel planar surfaces in the evaluation direction and determining a deviation between the measured relative location to an expected relative location.

14. The method according to claim 13, wherein the evaluation direction is a direction perpendicular to a working plane in which the layers are formed in the additive manufacturing process.

15. The method according to claim 13, wherein the evaluation direction is a direction parallel to a working plane in which the layers are formed in the additive manufacturing process.

16. The method according to claim 1, wherein the verification artefact is built as a separate object to the part during the additive manufacturing process.

17. The method according to claim 1, comprising building indicia into the verification artefact that encode information about the build, the indicia readable using the surface scanning probe.

18. A method of verifying a build of a part, in which the part is built in an additive manufacturing process by layerwise consolidation of material, the part built together with a verification artefact having a feature measurable with a surface sensing probe, the method comprising receiving measured geometric dimensions of the feature obtained by measuring the feature with the surface sensing probe, determining a deviation in the measured geometric dimension from an expected dimension for the feature and qualifying the build of the part based upon the deviation.

19. A method of determining an expected dimension to be used in the method of claim 1, the method comprising carrying out a plurality of builds, wherein each build comprises the building of a part together with a verification artefact, measuring a feature of each artefact with a surface sensing probe to determine a measured geometric dimension of the feature, verifying each part to determine whether the part meets predetermined specifications for the part, and determining the expected dimension from the measured geometric dimensions for ones of the verification artefacts built together with parts deemed to meet the predetermined specifications.

20. The method according to claim 19, wherein each build comprises the building of a nominally identical artefact and a nominally identical part with nominally identical scanning parameters.

21. The method according to claim 19, wherein the expected dimension comprises an average measured geometric dimension for the verification artefacts built together with parts deemed to meet the predetermined specifications.

22. The method according to claim 21, wherein the expected dimensions additionally comprises a standard deviation in the geometric dimension about the average and/or a range of acceptable values for the geometric dimension about the average.

23. A method of determining an expected dimension to be used in the method of the claim 1, the method comprising receiving measured geometric dimensions of a feature of a plurality of artefacts, each artefact built together with a part using an additive manufacturing process in a plurality of nominally identical builds, the measured geometric dimensions determined by measuring the feature with a surface sensing probe, receiving data on a verification of whether each part meets predetermined specifications for the part, and determining the expected dimension from the measured geometric dimensions for the ones of the verification artefacts built together with parts deemed to meet the predetermined specifications.

24. A method of carrying out variability management of an additive manufacturing apparatus comprising carrying out a plurality of builds with the additive manufacturing apparatus, wherein each build comprises the building of a verification artefact, each verification artefact having a nominally identical feature, measuring the nominally identical feature of each artefact with a surface sensing probe to determine a measured geometric dimension of the feature, and generating a flag that maintenance of the additive manufacturing apparatus is required based on a trend in the measured geometric dimensions across the plurality of builds.

25. A method of carrying out variability management of an additive manufacturing apparatus comprising receiving measured geometric dimensions of a nominally identical feature of a plurality of verification artefacts, each verification artefact built in separate builds in the additive manufacturing apparatus, the measured geometric dimensions determined by measuring the nominally identical feature with a surface sensing probe, and generating a flag that maintenance of the additive manufacturing apparatus is required based on a trend in the measured geometric dimensions across the plurality of builds.

26. A method of correlating build outcomes across a build volume of an additive manufacturing apparatus comprising building a plurality of nominally identical artefacts at different locations in the build volume, measuring geometric dimensions of a feature of each of the verification artefacts with a surface sensing probe, and comparing the measured geometric dimensions of each artefact to obtain a correlation between a build outcome for one location in the build volume and build outcomes for other locations in the build volume.

27. A method of correlating build outcomes across a build volume of an additive manufacturing apparatus comprising receiving geometric dimensions of a feature of each of a plurality of nominally identical artefacts measured with a surface sensing probe, the plurality of nominally identical artefacts built at different locations in the build volume, and comparing the measured geometric dimensions of each artefact to obtain a correlation between a build outcome for one location in the build volume and build outcomes for other locations in the build volume.

28. A data carrier having stored thereon instructions, which, when executed by a processor, cause the processor to carry out the method of claim 18.

29. A verification artefact used in connection with the method of claim 1, the verification artefact comprising a feature measurable with a surface sensing probe.

30. A method of encoding information into an object built using an additive manufacturing process, in which the object is built by layerwise consolidation of material, the method comprising building indicia into the verification artefact that encode information about the build, the indicia readable using a surface scanning probe.

31. A method according to claim 30, wherein the indicia comprises one or more coding features each having a set shape on a surface of the verification artefact, wherein the information is encoded through the formation of different dimensions of the set shape.
